(19) United States
(12) Patent Application Publication
(10) Pub. No.: US 2025/0023070 A1
(43) Pub. Date: Jan. 16, 2025

(54) METHOD OF MANUFACTURING HYDROGEN FUEL CELL HOSES AND RELATED PARTS

(71) Applicant: Akron Polymer Solutions, Inc., Rancho Santa Margarita, CA (US)

(72) Inventors: Douglas PASCHALL, Rancho Santa Margarita, CA (US); Michael Brendan RODGERS, Leander, TX (US); Adel F. HALASA, Akron, OH (US)

(21) Appl. No.: 18/897,348

(22) Filed: Sep. 26, 2024

Related U.S. Application Data
(62) Division of application No. 18/322,704, filed on May 24, 2023, now abandoned.
(60) Provisional application No. 63/365,205, filed on May 24, 2022.

(51) Int. Cl. H01M 8/04082; C08K 3/04

(52) U.S. Cl. CPC H01M 8/04216; C08K 3/042; C08K 2201/006

(57) ABSTRACT

A method of manufacturing a hydrogen fuel cell hose and component parts is disclosed herein, including blending a formaldehyde-based, semi-crystalline engineering thermoplastic with graphene, wherein the graphene has a thickness of less than about 3.2 nm, a particle size of between about 50 nm and about 10 μm, and contains greater than about 95% carbon, exfoliating the graphene into plates, wherein the graphene plates having substantially no carboxylic acid, alcohols, ketones, aldehydes, or hydroxyl groups on the graphene plate surface or graphene plate edges, and aligning the graphene plates into perpendicular alignment, such that the graphene plates provide a barrier to migration of oxygen, nitrogen, moisture, or water vapor molecules.

### I. BACKGROUND

This application is a divisional of U.S. Ser. No. 18/322,704, filed May 24, 2023, which claims priority to provisional patent application, U.S. Ser. No. 63/365,205, filed May 24, 2022, the contents of which are herein incorporated by reference. Power can be generated by converting the chemical energy of hydrogen to mechanical energy, either by reacting hydrogen with oxygen in a fuel cell to power electric motors, or by burning hydrogen in an internal combustion engine. As of 2021, there are two models of hydrogen automobiles available in select markets, i) the Toyota Mirai available since 2014, which is the world's first mass-produced dedicated fuel cell electric vehicle (FCEV), and ii) the Hyundai Nexo. The hydrogen powered tractor developed by Kenworth is a T680 model fuel cell electric vehicle (FCEV) in regular operation equipped with Toyota's fuel cell electric system.

Fuel cells in vehicles generate electricity using atmospheric oxygen and compressed hydrogen. The power then drives electric motors in the vehicle (FIG. 1). Benefits of hydrogen technology are fast refueling time (equivalent to gasoline) and long driving ranges on a single tank (advantageous over electric charging).

Hydrogen is transferred to an automobile or truck via a hose. Such hoses are designed for high gas pressure and are thus reinforced by wire braided onto the tube or spiraled wrapped. The tube can be an elastomer, such as compounded butyl rubber or polyoxymethylene.

Graphene is an allotrope, or one of the several physical forms of carbon; other examples being graphite, fullerenes, and diamond. At the atomic level, it is in the form of a sheet with a thickness nominally under about 1.0 nanometer and up to about 1 micron in diameter. Sheets of such dimensions when added to other materials to form composites facilitate increases in thermal and electrical conductivity and in the case of elastomer nanocomposites, improvements in hysteresis, compounding ingredient dispersion, aging resistance, and reductions in permeability.

At the molecular level, graphene has a hexagonal lattice structure of isolated, single-layer plates of graphene that can be directly seen with transmission electron microscopy (TEM) of sheets of graphene suspended between bars of a metallic grid. Some of these images showed a rippling of the flat sheet, with amplitude of about one to three nanometers. Graphene has a theoretical specific surface area (SSA) of 2500 to 2700 m2/g. This is much larger than for carbon black (typically smaller than 900 m2/g) or for carbon nanotubes. With sheet thickness of less than about 1.0 nanometer (diameters can be over about 1.0 micron), graphene is thus much greater than that observed with other rubber nanocomposites such as those containing clays. There are essentially three forms of graphene, i) graphene oxide (GO), ii) reduced graphene oxide and iii) pure graphene (FIG. 2). Pure graphene, sometimes referred to as pristine graphene, when exfoliated into monolayer sheets will be of an inert condition, i.e., no chemical functionality such as carboxylic acid, ketone, aldehyde, or hydroxyl groups on the graphene plate surface or plate edges observed in other graphene oxide derivatives.

### II. SUMMARY

Graphene in polymer or rubber nanocomposites has been reported to have many unique properties such as antioxidant properties, reductions in permeability, thermal conductivity, electrical conductivity, and reduction in permeability. Abrasion resistance of rubber nanocomposites is also noted, suggesting better tire wear. In addition, improvement in hysteresis as measured by the loss modulus divided by the storage modulus or tangent delta has also been reported. In this instance such improvements can lead to improvements or reductions in whole tire rolling resistance with no loss in traction qualities.

A nanocomposite is a polymer containing nano-sized dispersed particles such as graphene. In this section of the work rubber nanocomposites are based on isobutylene elastomers and graphene, under the commercial name, Prophene®, which has particles with large aspect ratios, i.e., where the graphene plate thickness is in the order of up to 1.0 micron, but the plate width can be between 0.3 nm (3 Å) and 1.0 nm (10 Å). The graphene will be exfoliated in butyl rubber, i.e., separated into individual sheets of sets of sheets, or several sheets together, but not in an aggregated state or intercalated condition with sheets stacked upon one another. Graphene, and specifically a pristine graphene, can be compounded into the polymer to form a polymer rubber nanocomposite. Pristine graphene is easier to exfoliate in such polymer systems.

Still other benefits and advantages of the present subject matter will become apparent to those skilled in the art to which it pertains upon a reading and understanding of the following detailed specification.

### III. BRIEF DESCRIPTION OF THE DRAWINGS

The present teaching is described hereinafter with reference to the accompanying drawings.

FIG. 1 depicts a typical fuel cell configuration on a vehicle;

FIG. 2 depicts various forms of graphene;

FIG. 3 shows a graph of the rapid reduction in permeability;

FIG. 4 shows the path of gas flow through rubber-graphene nanocomposite;

FIG. 5 shows a graph of hydrogen permeability;

FIG. 6 shows a graph of air permeability;

FIG. 7 shows a wire spiral-reinforced hydrogen fuel hose; and

FIG. 8 shows an innertube extrusion operation.

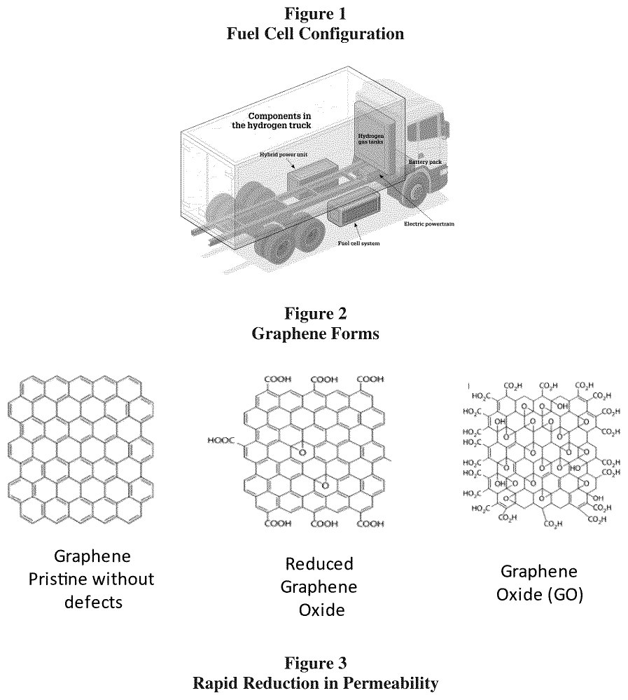

### IV. DETAILED DESCRIPTION

Graphene, in one example Prophene®, provided by Akron Polymer Solutions, is added to the rubber and mixed as noted above. Graphene will be added to a rubber formulation such as one based on butyl or halobutyl at levels from about 0.1 PHR to about 50.0 PHR, including from about 0.5 PHR to about 10.0 PHR, as well as from about 0.1 PHR to about 4.0 PHR, described in Table I.

TABLE I

| Form | Powder, dark grey, odorless | |
|---|---|---|
| Carbon | >95% | |
| Particle size | 150 nm to 10 μm | |
| Moisture, Oxygen, Ash | <0.75 wt. %, <2.0 wt. %, <4.5 wt. %, | |
| | respectively | |
| Resistivity | <150 | ohm cm |
| Particle (sheet) thickness) | <3.2 | nm |
| Particle layers | <16 | |
| Specific gravity | 2. | gm/cubic centimeter |
| Surface area (specific) | 100 | square m/gm |

Compound permeability would have initially had a very large decrease, but continuing to decrease as graphene levels increase. To those knowledgeable in such phenomenon, it is known to follow the Neilson model (see Neilson, J Macromol. Sci Chem A1 5 P929 1967). Gas-permeability decreases with increasing or graphene loading of only 0.4 vol % in rubber composites. This percolation threshold is about 40 times lower than that for clay-based composites. According to the Nielsen model on gas permeability, the thickness of an individual graphene-based sheet dispersed in the graphene styrene-butadiene rubber (SBR) composite with 2.0 vol. % of GO was predicted to be 1.47 nm (FIG. 3).

Graphene, when added to a butyl or halobutyl rubber compound formulation, can be in various forms which can be part of the present teaching:
1. As a powder;
2. In pastilles or pellets using wax as a carrier, aiding dust suppression;
3. In pre-weigh sealed low melt temperature polyethylene bags; or
4. Melt or solution blended with a compatible polymer such as butyl rubber or halobutyl rubber and then compounded as part of the total rubber hydrocarbon content.

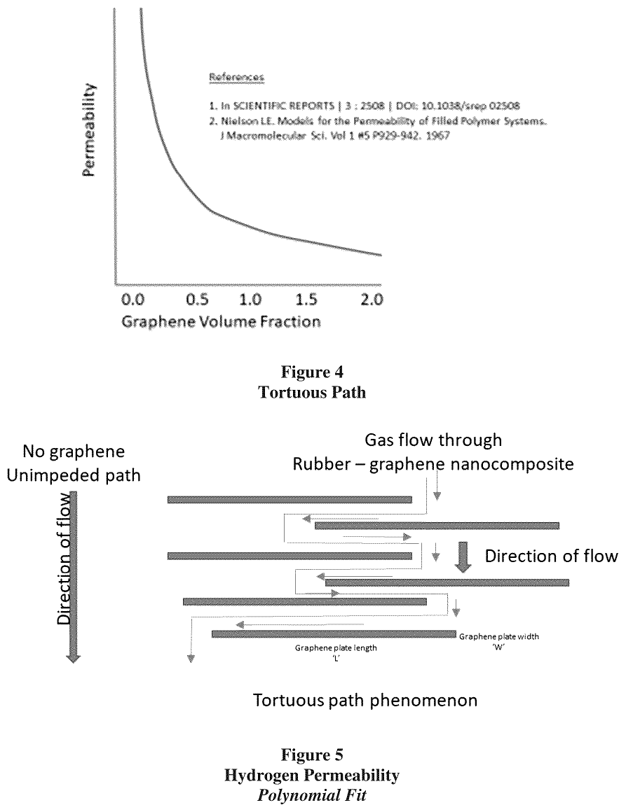

Graphene has an aspect ratio of near 1000, assuming the graphene plate thickness is about 1 nm. The plate length/diameter can be up to about 1 micron. The graphene can thus function as a barrier. The graphene exfoliates into sheets when added to the rubber compound, which improves the barrier properties when perpendicular alignment to the sheet direction is achieved. The graphene plates provide a barrier to oxygen and nitrogen migration, and moisture or water vapor molecules migrating through the liner compound of the tire or other product requiring such properties. Such gas molecule transport phenomenon is described as a “Tortuous Path” (FIG. 4). With continuing reference to the Figures, with the addition of graphene as a filler, there is no trade-off or loss in conventional processing and mechanical properties. Graphene has a very high aspect ratio. Small amounts have a large impact on reducing permeability. The nominal aspect ratio of graphene of up to 1000 compares with the typical aspect ratio of 20 for kaolin clay fillers. The clay fillers have to be added at about 40 PHR and also need a surfactant for compatibility. Due to the relatively large size of the graphene plates versus inorganic fillers, graphene can be added at about 1 PHR to about 2 PHR.

Graphene can be added to the high pressure hose components used to transfer hydrogen to an automobile, truck, or other vehicle and fuel cell application. The components include the hose innertube, innertube and internal components such as the seals, gaskets, tie gum, friction, or wire insulation compound, or other internal rubber component, or the cover compound.

High pressure hoses are built by spiraling a heavier gauge wire around the tube which may already have a fabric reinforcement layer applied to it. Up to six spiral wire layers can be used. Hoses are built on a rigid mandrel or pole, so they tend to be of much shorter lengths (40 meters). The manufacturing plant will require a larger mandrel preparation area with overhead cranes to lift the steel mandrels, re-configured tube extrusion, and wire reinforcement application lines. Hoses could therefore be produced by existing spiral-wire-reinforced hydraulic hose producers. Innertubes can be made from low permeability polymers such as compounded butyl rubbers, polyoxymethylene glycol, or POM, (also known as polyacetal and polyformaldehyde) as described in Table II. Butyl rubbers have a higher specific gravity (on the order of 0.94) than general purpose elastomers which are on the order of 0.89 to 0.90. Small increases in specific gravity of a polymer have a large impact on reducing permeability due to increased molecular or polymer chain packing. Polyoxymethylene glycol has a specific gravity of 1.41.

TABLE II
Polyoxymethylene
Description
Poly(oxymethylene) glycol; polymethylene glycol (POM)
Properties

| | |
|---|---|
| Chemical formula | (CH₂O)ₙ |
| Molar Mass | Variable |
| Appearance | Colorless Solid |
| Density | 1.41-1.42 g/cm³ |
| Magnetic susceptibility (χ) | −9.36 X 10⁻⁶ (SI, at 22° C.) |

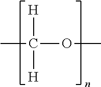

Graphene, when added to the innertube of a hydrogen fuel hose functions by two mechanisms—i) via creation of a tortuous path as described in FIG. 4 and illustrated by use of the Nielsen model, and ii) via hydrogen absorption on the surface of graphene, which is a function of graphene plate size (>16 carbon atom) and graphene plate amplitude.

Hydrogen collisions over 6-membered carbon rings versus carbon atom interactions can be mapped. Hydrogen also interacts with π-cloud in 6-C rings.

### EXAMPLE 1

Pristine graphene was added to the model bromobutyl compound formulation as shown in Table III. In this example tire model innerliner compounds were prepared containing graphene levels, reported in PHR, ranging from about 0.00 PHR to about 20.00 PHR. The graphene was first blended with bromobutyl rubber and then added as a master-batch to the compounds. The amount of free bromobutyl polymer added to the formulation was adjusted with the graphene master-batch to ensure the total polymer content is about 100.00 PHR as described earlier. Graphene was added at 0.5 PHR, 2.0 PHR, 5.00 PHR, 8.00 PHR, and 20.0 PHR. Compounds were prepared using a laboratory internal mixer familiar to those knowledgeable in rubber compound mixing, using a two-stage mixing procedure. The first stage is referred to as non-productive, followed by the final stage, or productive stage, where the vulcanization chemicals are added. The formulations are shown in Table III. Though not necessary, a re-mill can be added which can be included in the mixing procedure should it so be desired. A re-mill is a procedure where the compound is passed through a mixer for a short period of time so as to optimize final compound viscosity.

TABLE III
Halobutyl Polymers Compound Formulations with Prophene

| | | | | | | |
|---|---|---|---|---|---|---|
| Compound | 1 | 2 | 3 | 4 | 5 | 6 |

| Masterbatch of BIIR | | 0.00 | 1.83 | 7.33 | 18.33 | 29.33 | 73.30 |
|---|---|---|---|---|---|---|---|
| and Prophene | | | | | | | |
| Bromobutyl | 100.00 | | | | | | |
| Prophene | 37.50 | | | | | | |
| BIIR 2222 | | 100.00 | 98.67 | 94.67 | 86.67 | 78.67 | 46.70 |
| Carbon Black N660 | | 60.00 | 60.00 | 60.00 | 60.00 | 60.00 | 60.00 |
| Naphthenic oil | | 8.00 | 8.00 | 8.00 | 8.00 | 8.00 | 8.00 |
| Struktol 40MS | | 7.00 | 7.00 | 7.00 | 7.00 | 7.00 | 7.00 |
| Koresin | | 2.00 | 2.00 | 2.00 | 2.00 | 2.00 | 2.00 |
| Escorez 1102 | | 2.00 | 2.00 | 2.00 | 2.00 | 2.00 | 2.00 |
| Stearic Acid | | 1.00 | 1.00 | 1.00 | 1.00 | 1.00 | 1.00 |
| Zinc Oxide | | 1.00 | 1.00 | 1.00 | 1.00 | 1.00 | 1.00 |
| MBTS | | 1.25 | 1.25 | 1.25 | 1.25 | 1.25 | 1.25 |
| Sulfur | | 0.50 | 0.50 | 0.50 | 0.50 | 0.50 | 0.50 |
| Total PHR | | 182.75 | 183.25 | 184.75 | 187.75 | 190.75 | 202.75 |
| Prophene | | 0.00 | 0.50 | 2.00 | 5.00 | 8.00 | 20.00 |
| Hydrogen Permeability | | | | | | | |
| at 40° C. (ASTM D 1434-82) | | | | | | | |
| cc STP-cm/cm2-s-cm-Hg | | | | | | | |
| Mean | 40° C. | 4.81 | 4.6675 | 4.42 | 4.28 | 4.04 | 3.3525 |

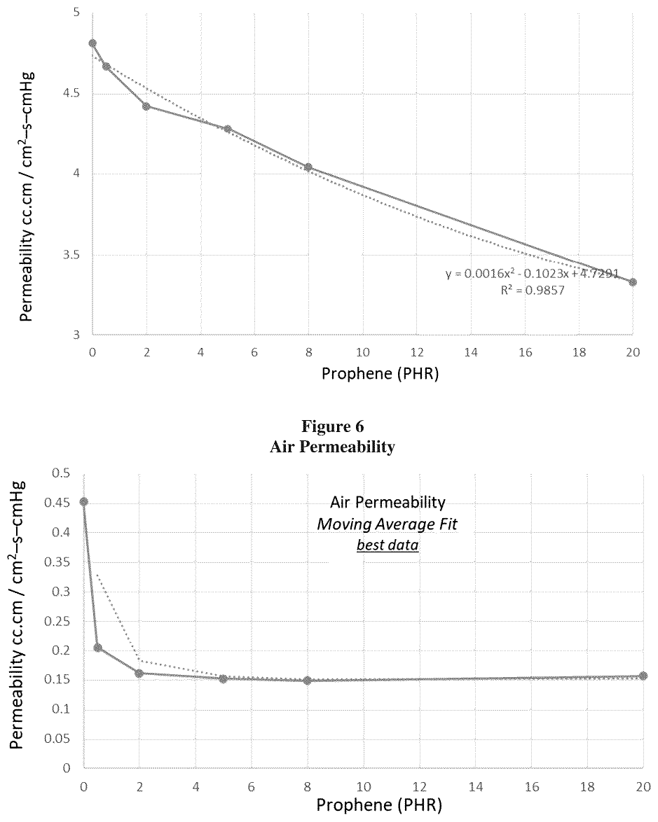

Hydrogen permeability is illustrated in FIG. 5, and FIG. 6 shows air permeability. It is demonstrated that graphene leads to substantial reductions in permeability, which can be achieved at very low levels of the pristine form of graphene. FIG. 6 illustrates that reductions in permeability can be achieved at exceptionally low levels of graphene when exfoliated.

Mooney viscosity (ML1+4) at 100° C. measured in accordance with ASTM D1646. Vulcanization kinetics and associated properties was measured by following the procedure in ASTM D5289. Tensile strength and associated data generated through measurement of tensile strength was determined following ASTM D412. Shore-A Hardness was measured following the method in ASTM D2240. Tear strength and adhesion were measured following ASTM D624. Hydrogen permeability was measured following the procedure based on ASTM D1434. Air permeability was similarly determined according to the method in ASTM D1434 and included for reference. The results for processing and mechanical properties are typical.

### EXAMPLE 2

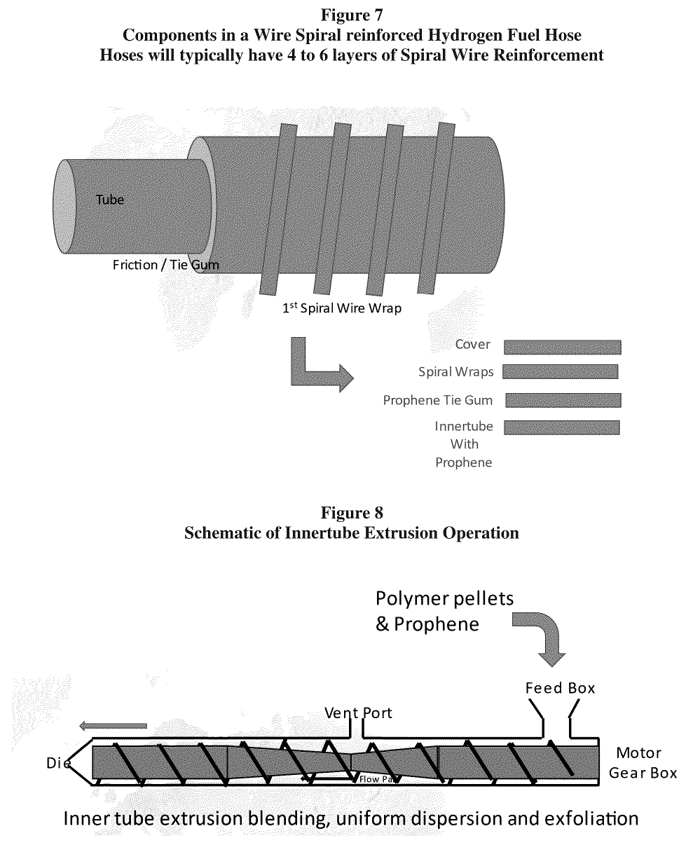

Graphene used in the hydrogen fuel hose can be added to the innertube compound which can be either composed of compounded butyl rubbers or polyoxymethylene glycol used in the innertube. Alternatively, or in addition to, graphene can be added to friction, tie gum, or wire reinforcement insulation materials or other structure internal components, or alternatively the tube, internal components (such as gaskets and seals), and cover (FIG. 7).

### EXAMPLE 3

Graphene can be added to the innertube of a hydrogen fuel hose by any traditional compounding methods using an internal mixer, such as a Banbury.

Masterbatch blends may also be prepared at the innertube extruder operation
1. Add graphene with polymer pellets;
2. Mixing in extruder;
3. Provides orientation along direction of flow; and
4. Shear will separate the graphene sheets (aid exfoliation).

Similarly at the cover extrusion operation.

For addition of graphene to the tie gum, barrier, friction, or wire coat compound, addition may occur at the Banbury or other internal mixer when the compounds are prepared, or at the extruder used to feed a calender used in forming tire gum sheets or wire coat preparation. The extrusion operating is thus illustrated in FIG. 8. The extruder may have a gear pump before the extruder die to maximize dispersion and exfoliation of the graphene.

Clause 1—A hose and component parts therefor including a formaldehyde-based, semi-crystalline engineering thermoplastic and graphene plate, wherein the graphene plate has a thickness of less than about 3.2 nm, a particle size of between about 50 nm and about 10 μm, and contains greater than about 95% carbon.

Clause 2—The hose and component parts of clause 1, wherein the graphene plate is present in an amount of between about 0.1 PHR and about 50.0 PHR.

Clause 3—The hose and component parts of clauses 1 or 2, wherein the graphene plate has a surface area from about 100 m²/gram to about 250 m²/gram.

Clause 4—The hose and component parts of clauses 1-3, wherein the graphene plate has an oxygen content of less than about 1%.

Clause 5—The hose and component parts of clauses 1-4, wherein the thickness of the graphene plate is less than about 1 nm and the aspect ratio of the graphene plate is about 1000.

Clause 6—The hose and component parts of clauses 1-5, wherein the graphene plate is present in an amount of between about 0.5 PHR and about 8.0 PHR.

Clause 7—The hose and component parts of clauses 1-6, wherein the graphene plate is pristine graphene.

Clause 8—The hose and component parts of clauses 1-7, wherein the formaldehyde-based, semi-crystalline engineering thermoplastic is polyoxymethylene glycol.

Clause 9—The hose and component parts of clauses 1-8, wherein the graphene plate is present in an amount of between about 1.0 PHR and about 2.0 PHR, wherein the hose and component parts have no clay fillers.

Clause 10—A method of manufacturing a hydrogen fuel cell hose and component parts including blending a formaldehyde-based, semi-crystalline engineering thermoplastic with graphene, wherein the graphene has a thickness of less than about 3.2 nm, a particle size of between about 50 nm and about 10 μm, and contains greater than about 95% carbon, exfoliating the graphene into plates, wherein the graphene plates having substantially no carboxylic acid, alcohols, ketones, aldehydes, or hydroxyl groups on the graphene plate surface or graphene plate edges, and aligning the graphene plates into perpendicular alignment, such that the graphene plates provide a barrier to migration of oxygen, nitrogen, moisture, or water vapor molecules.

Clause 11—The method of clause 10, wherein the graphene plate is present in an amount of between about 0.1 PHR and about 50.0 PHR.

Clause 12—The method of clauses 10 or 11, wherein the graphene plate has a surface area from about 100 m²/gram to about 250 m²/gram.

Clause 13—The method of clauses 10-12, wherein the graphene plate has an oxygen content of less than about 1%.

Clause 14—The method of clauses 10-13, wherein the thickness of the graphene plate is less than about 1 nm and the aspect ratio of the graphene plate is about 1000.

Clause 15—The method of clauses 10-14, wherein the graphene plate is present in an amount of between about 0.5 PHR and about 8.0 PHR.

Clause 16—The method of clauses 10-15, wherein the graphene plate is present in an amount of between about 1.0 PHR and about 2.0 PHR, wherein no clay fillers are added.

Clause 17—The method of clauses 10-16, wherein the graphene plate is pristine graphene.

Clause 18—The method of clauses 10-17, wherein the formaldehyde-based, semi-crystalline engineering thermoplastic is polyoxymethylene glycol.

Non-limiting aspects have been described, hereinabove. It will be apparent to those skilled in the art that the above methods and apparatuses may incorporate changes and modifications without departing from the general scope of the present subject matter. It is intended to include all such modifications and alterations in so far as they come within the scope of the appended claims or the equivalents thereof.

Having thus described the present teachings, it is now claimed:

1. A method of manufacturing a hydrogen fuel cell hose and component parts, the method comprising the steps of:
blending a formaldehyde-based, semi-crystalline engineering thermoplastic with graphene, wherein the graphene has a thickness of less than about 3.2 nm, a particle size of between about 50 nm and about 10 μm, and contains greater than about 95% carbon;
exfoliating the graphene into plates, wherein the graphene plates having substantially no carboxylic acid, alcohols, ketones, aldehydes, or hydroxyl groups on the graphene plate surface or graphene plate edges; and
aligning the graphene plates into perpendicular alignment, such that the graphene plates provide a barrier to migration of oxygen, nitrogen, moisture, or water vapor molecules.

2. The method of claim 1, wherein the graphene plate is present in an amount of between about 0.1 PHR and about 50.0 PHR.

3. The method of claim 2, wherein the graphene plate has a surface area from about 100 m²/gram to about 250 m²/gram.

4. The method of claim 3, wherein the graphene plate has an oxygen content of less than about 1%.

5. The method of claim 1, wherein the thickness of the graphene plate is less than about 1 nm and the aspect ratio of the graphene plate is about 1000.

6. The method of claim 2, wherein the graphene plate is present in an amount of between about 0.5 PHR and about 8.0 PHR.

7. The method of claim 6, wherein the graphene plate is present in an amount of between about 1.0 PHR and about 2.0 PHR, wherein no clay fillers are added.

8. The method of claim 1, wherein the graphene plate is pristine graphene.

9. The method of claim 1, wherein the formaldehyde-based, semi-crystalline engineering thermoplastic is polyoxymethylene glycol.
